(19) United States
(12) Patent Application Publication
(10) Pub. No.: US 2023/0399521 A1
(43) Pub. Date: Dec. 14, 2023

(54) PEROXIDE-FREE COATING COMPOSITIONS COMPRISING UNSATURATED POLYESTER

(71) Applicant: BASF SE, Ludwigshafen (DE)

(72) Inventors: Manfred BIEHLER, Ludwigshafen (DE); Irene GORMAN, Ludwigshafen (DE)

(21) Appl. No.: 18/252,631

(22) PCT Filed: Nov. 24, 2021
(86) PCT No.: PCT/EP2021/082825

§ 371 Date: May 11, 2023

(30) Foreign Application Priority Data
Nov. 27, 2020 (EP) 20210493.1

(51) Int. Cl. C09D 4/06; C09D 167/06; C09D 15/00

(52) U.S. Cl. CPC C09D 4/06; C09D 167/06; C09D 15/00

(57) ABSTRACT

Disclosed herein is a coating composition including at least one unsaturated polyester (A) including units of formula
a reactive diluent (B) including at least one polymerizable compound (B1),
at least one catalyst (C),
optionally at least one actinic radiation-activatable polymerization initiator (D),
optionally at least one solvent (E),
optionally at least one coating composition additive (F), and
optionally at least one polymer (G) different from the unsaturated polyester (A),
with the proviso that the coating composition does not include any peroxide. Also disclosed herein are
substrates coated with the coating composition, a process for the preparation of the coated substrates,
and compositions including
at least one unsaturated polyester (A) including units of formula
a reactive diluent (B) including at least one polymerizable compound (B1),
at least one catalyst (C), and
and optionally at least one solvent (E).

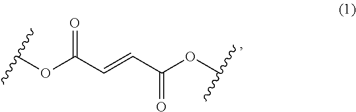 [SMILES: *OC(=O)/C=C/C(=O)O*]

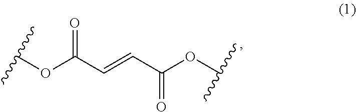 [SMILES: *OC(=O)/C=C/C(=O)O*]

The present invention relates to peroxide-free compositons and coating compositions comprising at least one unsaturated polyester, as well as to substrates coated with the coating composition, and to a process for the preparation of the coated substrates.

Coating compositions comprising unsaturated polyesters, co-polymerizable compounds and peroxides as polymerization initiator are known in the art (Polyester und Alkydharze, Ulrich Poth, Vincenz, second revised edition 2014, page 165 to 174). Coating composition comprising commonly used peroxides such as methyl ethyl keton peroxide, cyclohexanone peroxide and benzoyl peroxide require high temperatures for activation of the peroxide. For this reason, coating compositions comprising peroxides usually also contain a catalyst such as a Co(II) salt, which causes the activiation of the peroxide at room temperature. Therefore, the coating compositions comprising a peroxide and a catalyst are not storage stable at room temperature and have to be prepared shortly before application of the coating composition on the substrate, by mixing one coating composition component comprising the peroxide with the other coating composition component comprising the catalyst and usually also the unsaturated polyester and the co-polymerizable compouns. Thus, coating compositions comprising a peroxide and catalyst are two-component coating compositions. The preparation of the two-component coating compositions requires also the storage and handling of the peroxide component. Peroxide are often explosive, corrosive and/or servere skin-irritating and thus require adequate safety and health measures when stored and handled.

Thus, coating compositions comprising unsaturated polyesters, co-polymerizable compounds, peroxides and a catalyst have the disadvantages of being a two-component-coating composition and of requiring extra safety and health measures due to the peroxide component.

Peroxide-free coating compositions comprising unsaturated polyesters and co-polymerizable compounds are also kown in the art. Often, these coating compositions comprise an actinic-radiation, usually a UV-radiation, activatable polymerization initiator (Polyester und Alkydharze, Ulrich Poth, Vincenz, second revised edition 2014, page 175 to 177).

EP3492537A1 describes a resin for an active energy ray curable ink comprising a rosin-modified unsaturated polyester resin. The rosin-modified unsaturated polyester resin is a reaction product of a material component comprising rosins (a), alpha-beta-unsaturated carboxylic acids (b) and polyols (c), wherein the mol ratio of unsaturated bond based on alpha,beta-unsaturated carboxylic acids (b) with respect to total amount of material component is 0.05 to 2.00 mmol/kg, the rosins (a) comprise a stabilization-treated rosin at a ratio of 90 mass % or more with respect to the total amount of the rosins (a), and the alpha,beta-unsaturated carboxylic acid comprises alpha, beta-unsaturated dicarboxylic acids and the polyols (c) contain trihydric or more alcohol.

GB1363015 describes air-drying and light curing coating compositions that are based on polyesters. The composition comprises at least one unsaturated polyester comprising units derived from fumaric acid, at least one co-polymerizable monomer and at least one photoinitiator.

CN103409048A describes a photo-curable resin in which at least one air-drying monomer is introduced into an unsaturated polyester and at least two photoinitiators are used, which are a surface initiator and a deep initiator, respectively. The air-drying monomer is preferably tetrahydrophthalic anhydride or dicyclopentadiene. The surface layer initiator is preferably an alpha-hydroxyketone-based initiator, and the deep layer initiator is preferably an acylphosphine oxide-based initiator.

WO2012130975A1 describes an unsaturated polyester resin composition (C1) comprising (a) an unsaturated polyester comprising building blocks of formula —O—C(═O)—CH₂—C(═CH₂)—C(═O)—O— (1), (b) a cyclic monomer of formula (2) copolymerizable with the unsaturated polyester, and (c) a transition metal compound selected from cobalt, copper, manganese, iron, and their salts and complexes.

JP2004-115770 describes an actinic-ray curable resin composition comprising unsaturated polyester (A) and 1,6-hexanediol ethylene oxide modified diacrylate (B) of formula CH₂═CH—C(O)O—(CH₂CH₂O)m—CH₂—(CH₂)₄—CH₂—(O—CH₂—CH₂)n—O—C(O)—CH═CH₂ (1), wherein m+n=1 to 6. The unsaturated polyester (A) comprises ethylenically unsaturated dicarboxylic acid (a), dicarboxylic acid other than acid (a), ether group-containing polyhydric alcohol (b) and polyhydric alcohol other than alcohol (b) and allyl ether compound having at least one hydroxyl group (c).

WO2003101918 describes polyester compositions comprising an unsaturated polyester and a reactive diluent. WO2003101918 also describes curable compositions comprising the polyester composition. These curable compositions may contain a catalyst such as a free-radical or azo-alkane-type catalyst, or a radiaton-activatable initiator. These curable compositions may also contain a promoter such as a metal compound, for example a cobalt salt of an organic acid. Examples of reactive diluents are p-tert-butyl-styrene and ethylene glycol dimethacrylate.

JP2000-160035 describes a resin composition for gel coat comprising a resin (A) containing a polymerizable unsaturated bond group and a polymerizable unsaturated monomer (B).

It was the object of the present invention to provide peroxide-free coating compositions comprising unsaturated polyesters, which coating compositions avoid the disadvantages of peroxid-containing coating compositions such as being a two-component coating composition and requiring special safety and health meaures, and which coating compositions at the same time show improved properties for a peroxide-free coating composition in that substrates, in particular wood substrates, coated with the coating composition of the present invention show a low amount of polymerizable compounds extractable from the coated substrates upon storage.

This object is solved by the coating composition of claim 1, the composition of claim 15, the substrate of claim 17, and the process of claim 19.

The coating composition of the present invention comprises at least one unsaturated polyester (A) comprising units of formula

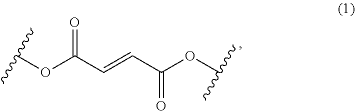

a reactive diluent (B) comprising at least one polymerizable compound (B1),
at least one catalyst (C),
optionally at least one actinic radiation-activatable polymerization initiator (D),
optionally at least one solvent (E),
optionally at least one coating composition additive (F), and
optionally at least one polymer (G) different from the unsaturated polyester (A),
with the proviso that the coating composition does not comprise any peroxide.

The unsaturated polyester (A) preferably comprises
units of formula

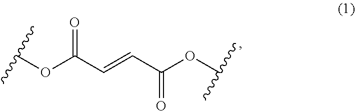

units of formula

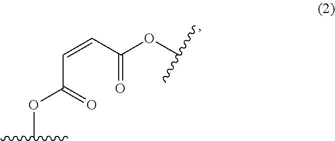

optionally units derived from at least one dicarboxylic acid carrying at least one olfinically unsaturated group or derivative thereof, different from the units of formula (1) or (2), and units derived from at least one diol.

The unsaturated polyester (A) can additionally comprise further units such as units derived from at least one dicarboxylic acid carrying no olefinically unsaturated groups or derivative thereof, from at least one polyol carrying at least three OH groups, at least one alcohol, from at least one polycarboxylic acids carrying at least three COOH groups or derivatives thereof and/or from at least one carboxylic acid or derivative thereof.

Preferably, unsaturated polyester (A) does not comprise units derived from itaconic acid.

The dicarboxylic acid carrying at least one olefinically unsaturated group can be any dicarboxylic acid carrying at least one, preferably one, olefinically unsaturated group.

Examples of dicarboxylic acid carrying at least one olefinically unsaturated group are citraconic acid, mesaconic acid, 1,2,3,6-tetrahydrophthalic acid, 3,4,5,6-tetrahydrophthalic acid, 2-methyl-1,2,3,6-tetrahydrophtalic acid, cis-5-norbornene-endo-2,3-dicarboxylic acid, cis-5-norbornene-exo-2,3-dicarboxylic acid, cis-5-norbornene-2-endo, 3-exo-dicarboxylic acid, itaconic acid and 2-methyleneglutaric acid.

The dicarboxylic acid carrying at least one olefinically unsaturated group is preferably selected from the group consisting of citraconic acid, mesaconic acid, 1,2,3,6-tetrahydrophtalic acid, 3,4,5,6-tetrahydrophthalic anhydride and 2-methyl-1,2,3,6-tetrahydrophtalic acid. The dicarboxylic acid carrying at least one olefinically unsaturated group is more preferably selected from the group consisting of 1,2,3,6-tetrahydrophtalic acid, 3,4,5,6-tetrahydrophthalic acid and 2-methyl-1,2,3,6-tetrahydrophtalic acid. The dicarboxylic acid carrying at least one olefinically unsaturated group is most preferably 1,2,3,6-tetrahydrophtalic acid.

Derivatives of the dicarboxylic acid carrying at least one olefinically unsaturated group can be the corresponding anhydride in monomeric or polymeric form, the corresponding mono- or di-C₁₋₄-alkyl-esters such as monomethyl ester, dimethyl ester, monoethyl ester, diethyl ester or mixed methyl ethyl esters, the corresponding amides, or the corresponding acid halides such as chlorides or bromides.

Examples of C₁₋₄-alkyl are methyl, ethyl, propyl, isopropy, n-butyl, sec-butyl and tert-butyl.

Preferred derivatives of of the dicarboxylic acid carrying at least one olefinically unsaturated group are the corresponding anhydride in monomeric form or the corresponding mono- or di-C₁₋₄-alkyl-esters.

The dicarboxylic acid carrying no olefinically unsaturated group can be any dicarboxylic acid carrying no olefinically unsaturated group.

Examples of aliphatic dicarboxylic acids carrying no olefinically unsaturated group are malonic acid, succinic acid, glutaric acid, adipic acid, pimelic acid, suberic acid, azelaic acid, sebacic acid, 1,11-undecanedicarboxylic acid, 1,12-dodecanedicarboxlyic acid, 2-methylmalonic acid, 2-ethylmalonic acid, 2-methylsuccinic acid and 2-ethylsuccinic acid. Examples of alicyclic dicarboxylic acids carrying no olefinically unsaturated group are cyclopentane-1,2-dicarboxylic acid, cyclopentane-1,3-dicarboxylic acid, cyclohexane-1,2-dicarboxylic acid, cyclohexane-1,3-dicarboxylic acid, cyclohexane-1,4-dicarboxylic acid, cycloheptane-1,2-dicarboxylic acid, 1,2-bis(carboxymethyl)-cyclohexane, 1,3-bis(carboxymethyl)-cyclohexane and 1,4-bis(carboxy-methyl)-cyclohexane. Examples of aromatic dicarboxylic acids carrying no olefinically unsaturated group are phthalic acid, isophthalic acid, terephthalic acid and 2,6-naphthalenic dicarboxylic acid.

Derivatives of the dicarboxylic acid carrying no olefinically unsaturated group can be the corresponding anhydride in monomeric or polymeric form, the corresponding mono- or di-C₁₋₄-alkyl-esters such as monomethyl ester, dimethyl ester, monoethyl ester, diethyl ester or mixed methyl ethyl esters, the corresponding amides, or the corresponding acid halides such as chlorides or bromides.

The polycarboxylic acids carrying at least three COOH groups can be any polycarboxylic acid carrying at least three COOH groups. The polycarboxylic acid carrying at least three COOH groups can carry at least one olefinically unsaturated group, but preferably it does carry no olefinically unsaturated group.

Examples of polycarboxylic acids carrying at least three COOH groups are 1,3,5-cyclohexane-tricarboxylic acid, 1,2,4-benzenetricarbocxylic acid, 1,3,5-benzenetricarbocxylic acid, 1,2,4,5-benzenetetracarboxylic acid and mellitic acid.

Derivatives of the polycarboxylic acids carrying at least three COOH groups can be the corresponding anhydride in monomeric or polymeric form, the corresponding mono- or di-C₁₋₄-alkyl-esters such as monomethyl ester, dimethyl ester, monoethyl ester, diethyl ester or mixed methyl ethyl esters, the corresponding amides, or the corresponding acid halides such as chlorides or bromides.

The carboxylic acid can be any carboxylic acid carrying excactly one COOH group. The carboxylic acid can carry at least one olefinically unsaturated group, but preferably it does carry no olefinically unsaturated group. Examples of carboxy acids are acetic acid, propionic acid, butanoic acid, 2-ethylhexanoic acid, benzoic acid or (meth)acrylic acid.

Derivatives of the carboxylic acid can be the corresponding mono- or di-C₁₋₄-alkyl-esters such as monomethyl ester, dimethyl ester, monoethyl ester, diethyl ester or mixed methyl ethyl esters, the corresponding amides, or the corresponding acid halides such as chlorides or bromides.

The diol can carry at least one olefinically unsaturated group, but preferably the diol does not carry olefinically unsaturated groups.

Examples aliphatic diols carrying no olefinically unsaturated group are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, heptane-1,7-diol, octane-1,8-diol, octane-1,2-diol, nonane-1,9-diol, decane-1,2-diol, decane-1,10-diol, dodecane-1,2-diol, dodecane-1,12-diol, neo-pentyl glycol, 2-methyl-pentane-2,4-diol, 2,4-dimethyl-pentane-2,4-diol, 2-ethyl-hexane-1,3-diol, 2,5-dimethyl-hexane-2,5-diol, 2,2,4-trimethyl-pentane-1,3-diol and pinacol.

Examples of alicyclic diols carrying no olefinically unsaturated groups are 1,1-bis(hydroxy-methyl)-cyclohexane, 1,2-bis(hydroxymethyl)-cyclohexane, 1,3-bis(hydroxymethyl)-cyclohexane, 1,4-bis(hydroxymethyl)-cyclohexane, 1,1-bis(hydroxyethyl)-cyclohexane, 1,2-bis(hydroxyethyl)-cyclohexane, 1,3-bis(hydroxyethyl)-cyclohexane, 1,4-bis(hydroxyethyl)-cyclohexane, 2,2,4,4-tetramethyl-1,3-cyclobutandiol, cyclopentane-1,2-diol, cyclopentane-1,3-diol, 1,2-bis(hydroxymethyl) cyclopentane, 1,3-bis(hydroxymethyl)cyclopentane, cyclohexane-1,2-diol, cyclohexane-1,3-diol, cyclohexane-1,4-diol, cycloheptane-1,3-diol and cycloheptane-1,4-diol and cycloheptane-1,2-diol, 2,2-bis(p-hydroxycyclohexyl)propane, 5-norbornene-2,2-dimethanol and norbornene-2,3-diol.

Examples of diols carrying no olefinically unsaturated groups and comprising at least one ether-group are diethylene glycol, triethylene glycol, dipropylene glycol, tripropylene glycol, polyethylene glycols HO(CH₂CH₂O)n-H, polypropylene glycols HO(CH(CH₃)—CH₂—O)n-H, n being an integer>=4, polyethylene-polypropylene glycols, the sequence of the ethylene oxide or propylene oxide units being blockwise or random, polytetramethyleneglycols, and polytetrahydrofurane, and ethoxylated or propoxylated bisphenol A.

Examples of diols carrying at least one olefinically unsaturated group are 2-butene-1,4-diol and 3-hexene-1,6-diol.

The diol is preferably a diol carrying no olefinically unsaturated groups, more preferably a diol carrying no olefinically unsaturated groups and comprising at least one ether-group, more preferably the diol is selected from the group consisting of diethylene glycol, triethylene glycol, di-propylene glycol and tripropylene glycol, and most preferably the diol is diethylene glycol.

The polyol carrying at least three OH groups can be any polyol carrying at least three OH groups. The polyol carrying at least three OH groups can carry at least one olefinically unsaturated group, but preferably, the polyol carrying at least three OH groups carry no olefinically unsaturated group.

Examples of polyols carrying at least three OH groups and no olefinically unsaturated group are glycerol, trimethylolmethane, 1,1,1-trimethylolethane, 1,1,1-trimethylolpropane, 1,2,4-butanetriol, pentaerythritol, diglycerol, triglycerole, condensates of at least four glycerols, di(trimethylolpropane), di(pentaerythritol, 1,3,5-tris(2-hydroxyethyl) isocyanurate, condensates of the above listed polyols carrying at least three OH groups with ethylene oxide, propylene oxide and/or butylene oxide, inositol, sugars such as glucose, fructose and sucrose, sugar alcohols such as sorbitol, mannitol, threitol, erythritol, adonitol (ribitol), arabitol (lyxitol), xylitol, dulcitol (galactitol), malitol and isomalt.

The alcohol can be any alcohol carrying exactly one OH group. The alcohol carrying exactly one OH group can carry at least one olefinically unsaturated group, but preferably, the alcohol carrying exactly one OH group carry no olefinically unsaturated group

Examples of alcohols carrying no olefinically unsaturated group are ethanol, 1-propanol, isopropanol, 1-butanol, 1-pentanol, 1-hexanol, 1-hepanol and 1-octanol. An example of an alcohol carrying at least one olefinically unsaturated group is 2-hydroxyethyl (meth)acrylacte.

Preferred are unsaturated polyesters (A), wherein the molar ratio of units of formula (1) to the sum of units of formulae (1) and (2) is in the range of 50 to 99%, preferably in the range of 70 to 98%, even more preferably in the range of 80 to 97% and most preferably in the range of 85 to 95%.

The molar ratio of units of formula (1) to the sum of units of formulae (1) and (2) can be determined by ¹H-NMR.

Preferred are unsaturated polyester (A), wherein the molar ratio of units of formula (1) to the sum of units of formula (1), units of formula (2) and units derived from at least one dicarboxylic acid carrying at leat one olefinically unsaturated group or a derivative thereof different from the units of formula (1) and (2), is the range of 50 to 90%, more preferably in the range of 40 to 80%, and most preferably in the range of 50 to 75%.

The molar ratio of units of formula (1) to the sum of units of formulae (1) and (2) and units derived from at least one dicarboxylic acid carrying at least one olefinically unsaturated group or derivative thereof different from the units of formula (1) and (2) can be determined by ¹H-NMR.

Preferred are unsaturated polyester (A), wherein the units derived from at least one unsaturated dicarboxylic acid or derivative thereof different from the units of formulae (1) and (2) are present and comprise units of formula

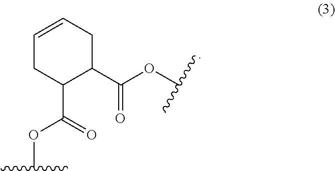

The unsaturated polyester (A) preferably comprises 10 to 50 weight %, more preferably 20 to 40 weight % and most preferably from 30 to 35 weight % of units of formula (1) based on the weight of polyester (A).

The unsaturated polyester (A) preferably comprises 0 to 20 weight %, more preferably 0 to 10 weight % and most preferably from 1 to 6 weight % of units of formula (2) based on the weight of polyester (A).

The unsaturated polyester (A) preferably comprises 0 to 50 weight %, more preferably 10 to 40 weight % and most preferably from 15 to 25 weight % of units derived from at least one dicarboxylic acid carrying at least one olefinically unsaturated group or derivative thereof, different from the units of formula (1) and (2), based on the weight of polyester (A).

The unsaturated polyester (A) preferably comprises 20 to 75 weight %, more preferably 30 to 60 weight % and most preferably from 40 to 60 weight % of units derived from at least one diol, based on the weight of the unsaturated polyester (A).

The ratio of the sum of the weights of units of formula (1), units of formula (2), units derived from dicarboxylic acid carrying at least one olefinically unsaturated group or derivative thereof, different from the units of formula (1) and (2) and of units derived from diol to the weight of polyester (A) is preferably at least 70%, more preferably at least 80%, even more preferably at least 90%, and most preferably at least 95%.

The unsaturated polyester (A) preferably comprises below 20 weight %, more preferably below weight %, most preferably below 1 weight % of units derived from polyols carrying at least three OH groups based on the weight of the unsaturated polyester (A).

The unsaturated polyester (A) preferably comprises below 20 weight %, more preferably below 10 weight %, most preferably below 1 weight % of units derived from carboxylic acids carrying exactly one COOH group based on the weight of the unsaturated polyester (A).

Most preferably, the molar ratio of the sum of units of formula (1), units of formula (2), units derived from at least one dicarboxylic acid or derivative thereof, different from units of formula (1) and (2) and units derived from at least diol, to all units of the unsaturated polyester (A), is at least 70%, preferably at least 80% more preferably at least 90%.

Most preferably, the unsaturated polyester (A) comprising units of formula (1) essentially consists of units of formula (1), units of formula (2), units derived from at least one dicarboxylic acid carrying at least one olefinically unsaturated group or derivative thereof, different from the units of formula (1) and (2), and units derived from at least one diol.

“Consting essentially of” means that the molar ratio of the sum of units of formula (1), units of formula (2), units derived from at least one dicarboxylic acid carrying at least one olefinically unsaturated group or derivative thereof, different from units of formula (1) and (2) and units derived from at least diol, to all units of the unsaturated polyster (A), is at least 95%.

The density of units of formula (1) is preferably at least 2.2 mmol units of formula (1)/g unsaturated polyester (A), more preferably at least 2.5 units of formula (1)/g unsaturated polyester (A), even more preferably at least 2.7 mmol units of formula (1)/g unsaturated polyester (A), more preferably at least 2.8 mmol units of formula (1)/g unsaturated polyester (A).

The density of units of formula (1) is preferably at most 6.0 mmol units of formula (1)/g unsaturated polyester (A), more preferably at most 5.0 mmol units of formula (1)/g unsaturated polyester (A), even more preferably at most 4.5 mmol units of formula (1)/g unsaturated polyester (A), more preferably at most 4.0 mmol units of formula (1)/g unsaturated polyester (A).

The number-average molecular weight Mn of the unsaturated polyester (A) comprising units of formula (1) can be in the range of from 400 to 10000 g/mol, preferably it is in the range of from 400 to 2000 g/mol, even more preferably in the range of from 500 to 1500 g/mol, and more preferably in the range of from 600 to 1100 g/mol. The number-average molecular weight Mn of the unsaturated polyester (A) can be determined using gel permeation chromatography according using polystyrene standards.

The weight-average molecular weight Mw of the unsaturated polyester (A) comprising units of formula (1) can be in the range of from 500 to 20000 g/mol, preferably it is in the range of from 1000 to 8000 g/mol and more preferably in the range of from 3000 to 6000 g/mol. The weight-average molecular weight Mw of the unsaturated polyester (A) can be determined using gel permeation chromatography using polystyrene standards.

The coating composition of the present invention preferably comprises 10 to 80%, more prefebly 20 to 60%, most preferably 25 to 50% by weight unsaturated polyester (A) based on the weight of the composition.

The unsaturated polyester (A) comprising units of formula (1) can be prepared by methods known in the art.

Preferably, the unsaturated polyester (A) comprising units of formula

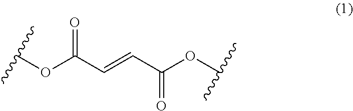

is prepared by a process, which process comprises the steps of
(i) esterifying
maleic acid or a maleic acid derivative or a mixture thereof,
optionally at least one dicarboxylic acid carrying at least one olefinically unsaturated group or derivative thereof, which is not maleic acid, fumaric acid or a derivative thereof, and
at least one diol,
to form an unsaturated polyester precursor, and
(ii) treating the unsaturated polyester precursor of the first step at a temperature of above 210° C., preferably at a temperature of above 215° C., and more preferably at a temperature in the range of 218 to 250° C., to yield the unsaturated polyester (A) comprising units of formula (1).

Derivatives of maleic or fumaric acid can be the corresponding anhydride in monomeric or polymeric form, the corresponding mono- or di-C₁₋₄-alkyl-esters such as monomethyl ester, dimethyl ester, monoethyl ester, diethyl ester or mixed methyl ethyl esters, the corresponding amides, or the corresponding acid halides such as chlorides or bromides.

The first step is preferably performed at temperatures in the range of 100 to 210° C., preferably in the range of 120 to 200° C.

The esterification reaction can be performed at a pressure in the range of 10 mbar to 10 000 mbar, preferably at a pressure in the range of 10 to 2000 mbar, more preferably at a pressure in the range of 10 to 1200 mbar, most preferably at a pressure in the range of 100 to 1100 mbar, and in particular at atmospheric pressure.

The catalyst can be selected from the group consisting of acidic inorganic catalysts, acidic organic catalysts, organometallic catalysts and mixtures thereof.

Examples of acidic inorganic catalysts are sulfuric acid, sulfates and hydrogen sulfates such as sodium hydrogen sulfate, phosphoric acid, phosphonic acid, hypophosphoric acid aluminium sulfate hydrate, alum, acidic silica gel (pH<=6, especially pH<=5) and acidic aluminium oxide.

Examples of acidic organic catalysts are organic compounds containing phosphate groups, sulfonic acid groups, sulfate groups or phosphonic acid groups, such as para-toluene sulfonic acid. Further examples of acidic organic catalysts are acidic ion exchangers such as polystyrene resins being crosslinked with divinylbenzene and containing sulfonic acid groups.

Examples of organometallic catalysts are organic aluminium catalysts such as tris(n-butyloxy)aluminium, tris(isopropyloxy)aluminium and tris(2-ethylhexoxy)aluminium, as well as organic titanium catalysts such as titanium(IV) butoxide, tetra(isopropyloxy)titanium (IV) and tetra(2-ethylhexoxy)titanium(IV), organic tin catalysts such as dibutyltin oxide, diphenyltin oxide, dibutyltin dichloride, tin(II)di(n-octanoate), tin(II) di(2-ethylhexanoate), tin(II) laurate, dibutyltin diacetate, dibutyltin dilaurate, dibutyltin dimaleate and dioctyltin diacetate as well as organic zinc catalysts such as zinc acetate.

Preferably, the esterification step is performed without a catalyst.

The esterification step can be performed in the presence of a solvent.

Examples of suitable solvents include hydrocarbons such as n-heptane, cyclohexene, toluene, ortho-xylene, meta-xylene, para-xylene, xylene isomer mixture, ethylbenzene, chlorobenzene, ortho- and meta-dichlorobenzene. Of further suitability as solvents in the absence of acidic catalysts are ethers such as dioxane or tetrahydrofuran, and ketones such as methyl ethyl ketone and methyl isobutyl ketone.

Preferably, the amount of solvent, if present at all, is below 5 weight % based on the weight of the reaction mixture of the esterification step.

Water formed during the esterification step can be removed continuously, for example by distillation. Water can also be removed by stripping or by performing the reaction in the presence of a water-removing agent such as MgSO₄ and Na₂SO₄. Preferably, water is removed by distillation, optionally in combination with other water-removal methods. If other volatile components, for example methanol or ethanol, are formed during the reaction, these can also be removed, for example by distillation or stripping.

Preferably, the esterification reaction is carried out under a gas, which is inert under the reaction conditions. Suitable inert gases include nitrogen and argon.

The first step can be stopped when the desired acid value of the unsaturated polyester (A) is reached.

The second step can be performed at a pressure in the range of 10 mbar to 10 000 mbar, preferably at a pressure in the range of 10 to 2000 mbar, more preferably at a pressure in the range of 10 to 1200 mbar, most preferably at a pressure in the range of 100 to 1100 mbar, and in particular at atmospheric pressure.

In the second step, the maleic acid derived units at least partly isomerize to units of formula (1).

The reactive diluent (B) comprising at least one polymerizable compound (B1) preferably only comprises polymerizable compounds. The reactive diluent preferably does not comprise polymerizable compounds carrying OH and/or COOH groups.

A polymerizable compound can be any compound carrying at least one polymerizable group.

Polymerizable group is any group that polymerizises by a radical polymerization mechanism.

The polymerizable compound (B1) can be any compound carrying at least one polymerizable group.

Examples of compounds carrying at least one polymerizable group are compounds carrying at least one polymerizable group independently selected from the group consisting of vinyl, (meth)allyl and (meth)acryloyl group, as well as C₄₋₁₀-dicarboxylic acid derivatives carrying at least one olefinically unsaturated group in alpha, beta-position. “(Meth)acryloyl” includes methacryloyl and acryloyl. (Meth)allyl includes methallyl and allyl.

Examples of C₄₋₁₀-dicarboxylic acid derivatives carrying at least one olefinically unsaturated group in alpha, beta-position are maleic acid derivatives, fumaric acid derivatives, itaconic acid derivatives, citraconic acid derivatives, mesaconic acid derivatives and 2-methylenglutaric acid derivatives. The derivatives can be the anhydride or the di(C₁₋₂₀-alkyl) esters.

Examples of maleic acid derivatives are maleic anhydride and di(C₁₋₂₀-alkyl) esters of maleic acid such as the dimethyl ester of maleic acid, the ethyl methyl ester of maleic and the diethyl ester of maleic acid. Examples of fumaric acid derivative are di(C₁₋₂₀-alkyl) ester of fumaric acid such as as the dimethyl ester of fumaric acid, the ethyl methyl ester of fumaric acid and the diethyl ester of fumaric acid.

Examples of compounds carrying at least one polymerizable group independently selected from the group consisting of vinyl, (meth)allyl and (meth)acryloyl group, are compounds carrying at least one vinyl group and compounds carrying at least one (meth)allyl group and compounds carrying at least one (meth)acryloyl group.

Examples of compounds carrying at least one vinyl group, are styrene-type compounds, vinyl ester-type compounds and viny-ether-type compounds.

Examples of styrene-type compounds are styrene, p-tert-butylstyrene, p-methylstyrene, o-methylstyrene, 2-vinylnaphthalene and divinylstyrene.

The reactive diluent (B) preferably does not comprise styrene-type compounds.

An examples of a vinyl ester-type compound is vinyl acetate.

Examples of vinyl ether-type compounds are ethylene glycol divinyl ether, ethylene glycol monovinyl ether, di(ethylene glycol) divinyl ether, di(ethylene glycol) monovinyl ether, tri(ethylene glycol) divinyl ether, tri(ethylene glycol) monovinyl ether, trimethylolpropane trivinyl ether, 1,4-cyclohexanedimethanol divinyl ether, 1,4-cyclohexanedimethanol monovinyl ether, methyl vinyl ether, ethyl vinyl ether, 2-hydroxyethyl vinyl ether, isobutyl vinyl ether, 4-hydroxybutyl vinyl ether, tert-amyl vinyl ether, dodecyl vinyl ether, 1,4-butanediol divinyl ether, 1,6-hexanediol divinyl ether, cyclohexyl vinyl ether and 2,2-bis[4-[2-(vinyloxy)ethoxy]-phenyl]propane and 1,4-bis[2-(vinyloxy)ethoxy]benzene.

Examples of compounds carrying at least one (meth)ally group are (meth)allyl ester-type compounds and (meth)allyl-ether-type compounds.

Examples of (meth)allyl ester-type compounds are di(meth)allyl phthalate and tri(meth)allylcyanurate. Examples of (meth)allyl-ether-type compounds are (meth)allyl ether and trimethylolpropane diallyl ether.

Examples of compounds carrying at least one (meth)acryloyl group are compounds carrying at one (meth)acryloyl group, compounds carrying two (meth)acryloyl groups and compounds carrying at least three (meth)acryloyl groups.

Examples of compounds carrying one (meth)acryloyl group are C₁₋₂₀-alkyl(meth)acrylate, C₅₋₁₂-cycloalkyl(meth)acrylate, 2-norbonyl (meth)acrylate, [C₁₋₁₀-alkoxy(C₁₋₁₀-alkoxy)₀₋₅]C₁₋₁₀-alkyl-(methacrylate), glycidyl(meth)acrylate, (meth)acrylamide, acetoacetoxy(C₂₋₆-alkyl) (meth)acrylate, meth)allyl (meth)acrylate and 2-(2′-vinyloxyethoxy)ethyl (meth)acrylate.

Examples of C₁₋₂₀-alkyl(meth)acrylate are methyl(meth)acrylate, ethyl(meth)acrylate, n-propyl(meth)acrylate, butyl(meth)acrylate, isobutyl(methacrylate), sec-butyl(meth)acrylate, tert-butyl(meth)acrylate, pentyl(meth)acrylate, isopentyl(meth)acrylate, 2-methylbutyl(meth)acrylate, amyl(meth)acrylate, hexyl(meth)acrylate, 2-ethylbutyl(meth)acrylate, heptyl(methacrylate, octyl (meth)acrylate, 2-ethylhexyl(meth)acrylate, 2-propylheptyl(meth)acrylate, nony(meth)acrylate), decyl(methacrylate), isodecyl(methacrylate), undecyl(meth)acrylate and dodecyl(meth)acrylate, trodecyl (meth)acryte, tetradecyl(meth)acrylate, pentadecyl (meth)acrylate, hexadecyl (meth)acrylate, heptadecyl (meth)acrylate, octadecyl (meth)acrylate and non-adecyl(meth)acrylate.

Examples of [C₁₋₁₀-alkoxy(C₁₋₁₀-alkoxy)₀₋₅]C₁₋₁₀-alkyl(methacrylate) are 2-methoxyethyl-(meth)acrylate,2-ethoxyethyl(meth)acrylate, 4-methoxybutyl(meth)acrylate, 2-(2′-methoxy-ethoxy)ethyl(meth)acrylate and 2-(2′-ethoxyethoxy)ethyl(meth)acrylate.

Examples of C₅₋₁₂-cycloalkyl(meth) acrylate are cyclopentyl(meth)acrylate and cyclohexyl(meth)acrylate and cycloheptyl (meth)acrylate.

Examples of acetoacetoxy(C₂₋₆-alkyl) (meth)acrylate are acetoacetoxyethyl (meth)acrylate, acetoacetoxypropyl (meth)acrylate and acetoacetoxybutyl (meth)acrylate.

Examples of compounds carrying two (meth)acryloyl groups are 1,2-ethyleneglycol di(meth)acrylate, ethoxylated 1,2-ethyleneglycol di(meth)acrylate, propoxylated 1,2-ethyleneglycol di(meth)acrylate, 1,2-propyleneglycol di(meth)acrylate, ethoxylated 1,2-propyleneglycol di(meth)acrylate, propoxylated 1,2-propyleneglycol di(meth)acrylate, 1,3-propyleneglycol di(meth)acrylate, ethoxylated 1,3-propyleneglycol di(meth)acrylate, propoxylated 1,3-propyleneglycol di(meth)acrylate, 1,2-butanediol di(meth)acrylate, ethoxylated 1,2-butanediol di(meth)acrylate, propoxylated 1,2-butanediol di(meth)acrylate, 1,3-butanediol-di(meth)acrylate, ethoxylated 1,3-butanediol-di(meth)acrylate, propoxylated 1,3-butanediol-di(meth)acrylate, 1,4-butanediol di(meth)acrylate, ethoxylated 1,4-butanediol di(meth)acrylate, propoxylated 1,4-butanediol di(meth)acrylate, neopentylglycol di(meth)acrylate, ethoxylated neopentylglycol di(methacrylate), propoxylated neopentylglycol di(meth)acrylate, 1,6-hexanediol di(meth)acrylate, 1,7-heptandiol di(methacrylate), 1,8-octanediol di(methacrylate), 1,9-nonanediol di(meth)acrylate, 1,10-decanediol di(methacrylate), 1,2-bis(hydroxymethyl)-cyclohexane di(methacrylate), 1,4-bis(hydroxymethyl)-cyclohexane di(methacrylate, ethoxylated 1,4-bis(hydroxymethyl)-cyclohexane di(methacrylate), propoxylated 1,4-bis(hydroxymethyl)-cyclohexane di(methacrylate), diethyleneglycol di(meth)acrylate, triethylene glycol di(meth)acrylate, tetraethylene glycol di(meth)acrylate, dipropylene glycol di(meth)acrylate, tripropylene glycol di(meth)acrylate, tetrapropylene glycol di(meth)acrylate, polyethylene glycols di(methacrylate), polypropylene glycols di(meth)acrylate, polyethylene-polypropylene glycol di(meth)acrylate, the sequence of the ethylene oxide or propylene oxide units being blockwise or random, polytetramethyleneglycol di(meth)acrylate, polytetrahydrofurane di(meth)acrylate, bisphenol A di(methacrylate), ethoxylated bisphenol A di(methacrylate), propoxylated bisphenol A di(methacrylate), bisphenol A diglycidyl ether di(meth)acrylate and resorcinol diglycidyl ether di(meth)acrylate.

Examples of compounds carrying at least three (meth)acryloyl groups are glycerol tri(meth)acrylate, ethoxylated glycerol tri(meth)acrylate, propoxylated glycerol tri(meth)arcylate, mixed ethoxylated/propoxylated glycerol tri(meth)acrylate, 1,1,1-trimethylolpropane tri(meth)acrylate, ethoxylated 1,1,1-trimethylolpropane tri(meth)acrylate, propoxylated 1,1,1-trimethylolpropane tri(meth)acrylate, 1,1,1-trimethylolethane tri(meth)acrylate, ethoxylated 1,1,1-trimethylolethane tri(meth)acrylate, propoxylated 1,1,1-trimethylolethane tri(meth)acrylate, pentaerythritol tetra(meth)acrylate, ethoxylated pentaerythritol tetra(meth)acrylate, propoxylated pentaerythritol tetra(meth)acrylate, di(1,1,1-trimethylolpropane), ethoxylated di(1,1,1-trimethylolpropane) tetra(meth)acrylate, propoxylated di(1,1,1-trimethylolpropane) tetra(meth)acrylate, dipentaerythritol hexa(meth)acrylate, ethoxylated dipentaerythritol hexa(meth)acrylate, propoxylated dipentaerythritol hexa(meth)acrylate, 1,3,5-tris(2-hydroxyethyl) isocyanurate tri(meth)acrylate, ethoxylated 1,3,5-tris(2-hydroxyethyl) isocyanurate tri(meth)acrylate and propoxylated 1,3,5-tris(2-hydroxyethyl) isocyanurate tri(meth)acrylate.

Preferably, the reactive diluent (B) only consists of compounds carrying at least one (meth)acryloyl group.

Preferably, the polymerizable compound (B1) is a compound carrying at least one (meth)acryloyl group. More preferably, the polymerizable compound (B1) is a compound carrying two (meth)acryloyl groups.

Even more preferably, the polymerizable compound (B1) is selected from the group consisting of diethyleneglycol di(meth)acrylate, triethylene glycol di(meth)acrylate, tetrathylene glycol di(methacrylate), dipropylene glycol di(meth)acrylate, tripropylene glycol di(meth)acrylate tetrapropylene glycol di(meth)acrylate, glycerol tri(meth)arcylate, mixed ethoxylated/propoxylated glycerol tri(meth)acrylate, 1,1,1-trimethylolpropane tri(meth)acrylate, ethoxylated 1,1,1-trimethylolpropane tri(meth)acrylate and propoxylated 1,1,1-trimethylolpropane tri(meth)acrylate, wherein the average of propoxylene oxide and/or ethylene oxide units is in the range of of 3 to 6.

Most preferably, the polymerizable compound (B1) is independently selected from the group consisting of diethyleneglycol di(meth)acrylate, triethylene glycol di(meth)acrylate, tetraethylene glycol di(methacrylate), dipropylene glycol di(meth)acrylate, tripropylene glycol di(meth)acrylate and tetrapropylene glycol di(meth)acrylate.

In particular, the polymerizable compound (B1) is dipropylene glycol diacrylate.

If the polymerizable compound (B1) is independently selected from the group consisting of diethyleneglycol di(meth)acrylate, triethylene glycol di(meth)acrylate, tetrathylene glycol di(methacrylate), dipropylene glycol di(meth)acrylate, tripropylene glycol di(meth)acrylate and tetrapropylene glycol di(meth)acrylate, the reactive diluent (B) can additionally comprise at least one further polymerizable compound selected from the group consisting of C₁₋₂₀-alkyl-(meth)acrylate, C₅₋₁₂-cycloalkyl(meth)acrylate, 2-norbonyl (meth)acrylate, 1,2-ethyleneglycol di(meth)acrylate, 1,2-propyleneglycol di(meth)acrylate, 1,3-propyleneglycol di(meth)acrylate, 1,2-butanediol di(meth)acrylate, 1,3-butanediol-di(meth)acrylate, 1,4-butanediol di(meth)acrylate, neopentylglycol di(meth)acrylate, 1,6-hexanediol di(meth)acrylate, 1,7-heptandiol di(methacrylate), 1,8-octanediol di(methacrylate), 1,9-nonanediol di(meth)acrylate, 1,10-decanediol di(methacrylate), glycerol tri(meth)acrylate, ethoxylated glycerol tri(meth)acrylate, propoxylated glycerol tri(meth)arcylate, mixed ethoxylated/propoxylated glycerol tri(meth)acrylate, 1,1,1-trimethylolpropane tri(meth)acrylate, ethoxylated 1,1,1-trimethylolpropane tri(meth)acrylate and propoxylated 1,1,1-trimethylolpropane tri(meth)acrylate.

If the polymerizable compound (B1) is dipropylene glycol diacrylate, the reactive diluent (B) can additionally comprise at least one further polymerizable compound selected from the group consisting of cyclohexyl methacrylate, 2-norbonyl methacrylate, 1,6-hexanediol diacrylate and propoxylated glycerol triarcylate having an average of propoxylene oxide units of 3 to 6.

Preferably, the weight ratio of the polymerizable compound (B1) to the reactive diluent (B) is at least 40%, preferably at least 55%, more preferably at least 70%, even more preferably at least 95%.

The weight ratio of the reactive diluent (B) to the sum of polyester (A) and reactive diluent (B) is preferably from 10 to 90%, more preferably from 20 to 80%, even more preferably from 30 to 75%, and most preferably from 35 to 70%.

The coating composition of the present invention preferably does not comprise styrene-type compounds.

Preferably, catalyst (C) is a metal salt or a metal complex.

Examples of metals are transition metals such as cobalt, iron, manganese and copper.

Examples of cobalt salts are cobalt C₂₋₂₀-carboxylates such as cobalt bis(acetate) and cobalt bis(2-ethylhexanoate).

C₂₋₂₀-carboxylates can be branched or unbrunched. Examples of C₂₋₂₀-carboxylates are acetate, propionate, butanoate, pentanoate, hexanoate, heptanoate, octanoate, 2-ethylhexanoate, nonoate, decanoate, undecanoate, dodecanoate, tridecanoate, tetradecanoate, pentadecanoate, heptadecanoate, octadecenoate and nonadecanoate.

Examples of cobalt complexes are cobalt acetylacetonates such as cobalt bis(acetylacetonate) and cobalt tris(acetylacetonate).

Examples of iron salts are iron halides such as iron dichloride and iron C₂₋₂₀-carboxylates such as iron bis (acetate) and iron bis (2-ethylhexanoate).

Examples of iron complexes are iron acetylacetonates such as iron tris(acetylacetonate).

Preferably, catalyst (C) is a metal salt or metal complex, wherein the metal is selected from the group consisting of cobalt and iron.

More preferably, catalyst (C) is a metal salt or metal complex, wheren the metal is cobalt.

Even more preferably, catalyst (C) is a cobalt salt.

Most preferably, catalyst (C) is a cobalt bis(C₂₋₂₀-carboxylate), in particular cobalt bis (2-ethyl-hexanoate).

The weight ratio of catalyst (C) to the sum of polyester (A) and reactive diluent (B) is preferably in the range of 0.001 to 1%, more preferably in the range of 0.01 to 0.5%, most preferably in the range of 0.02 to 0.1%.

The actinic radiation-activatable polymerization initiator (D) can be any initiator that can initiate a radical polymerization upon treatment with radiation.

The actinic radiation-activatable polymerization initiator (D) is preferably a UV radiation activatable polymerization initiator.

Examples of UV radiation-activatable polymerization initiators are UV radiation-activatable compounds selected from the group consisting of ketones and derivatives thereof, alpha-hydroxy ketones and derivatives thereof, alpha-amino ketones, benzoic acid and derivatives thereof, acylphosphine oxide, and mixtures thereof.

Examples of UV radiation-activatable ketons are 2,2-dimethoxy-2-phenylacetophenone, cyclohexyl phenyl ketone, benzophenone, 4-hydroxybenzophenone, 4-phenyl benzophenone and isopropyl-9H-thioxanthen-9-one.

An example of a UV radiation-activatable ketone derivative is benzil dimethyl ketal.

Examples of UV radiation activatable-alpha-hydroxy ketones are benzoin, 1-hydroxycyclohexyl phenyl ketone, 2-hydroxy-2-methyl-1-phenyl-1-propanone and oligo[2-hydroxy-2-methyl-1-[4-(1-methylvinyl)phenyl]propanone].

An example of a UV radiation-activatable derivative of an alpha-hydroxy ketone is benzoin methyl ether.

Examples of UV radiation-activatable alpha-amino ketones are 2-benzyl-2-dimethylamino 1-(4-morpholinophenyl) butanone-1,2-benzyl-2-dimethylamino-1-(4-morpholinophenyl)-1-butanone, 2-methyl-1-[4-meth-ylthiophenyl)-2-morpholinopropan-1-one and 4-(2-hydroxyethoxy)phenyl 2-hydroxy-2-propyl ketone.

Examples of UV radiation-activatable acylphosphine oxides are diphenyl(2,4,6-trimethylbenzoyl) phosphine oxide, phenyl bis(2,4,6-trimethylbenzoyl) phosphine oxide and bis(2,6-dimethoxybenzoyl)-2,4,4 trimethylpentylphosphine oxide.

Examples of UV radiation-activatable derivatives of benzoic acid are methyl-2-benzoyl benzoate and ethyl phenyl(2,4,6-trimethylbenzoyl) phosphinate.

Examples of mixtures thereof are a mixture of bis(2,6-dimethoxybenzoyl)-2,4,4 trimethylpentylphosphine oxide and 2-hydroxy-2-methylphenylpropan-1-one, and a mixture of 1-hydroxycyclohexyl phenyl ketone and benzophenone.

More preferably, the actinic radiation activatable polymerization initiator (D) is a UV radiation-activatable alpha hydroxy ketone or a derivate thereof.

Most preferably, the acinic radiation activatable polymerization initiator (D) is 1-hydroxy-cyclohexyl phenyl ketone.

The weight ratio of the actinic radiation polymerization initiator (D) to the sum of polyester (A) and reactive diluent (B) is preferably in the range of 0.05 to 20%, more preferably in the range of 0.1 to 10%, even more preferably in the range of 1 to 8%, and most preferably in the range of 2 to 6%.

The coating composition of the present invention does not comprise any peroxide. A peroxide is any compound comprising a —O—O— group. Examples of peroxides are methyl ethyl ketone peroxide, cyclohexane peroxide and benzoyl peroxide.

Preferably, the coating composition of the present invention does not contain any heat-activatable polymerization initiators at all. Examples of heat-activatable polymerization initiators are peroxides and azo compounds. Azo compounds are compounds comprising a —N═N— group.

The solvent (E) can be any suitable organic solvent.

Examples of organic solvents are esters, ketones, amides, ethers and aromatic hydrocarbons and mixtures thereof.

Examples of esters of are ethyl acetate, butyl acetate, 1-methoxy-2-propyl acetate, 2-butoxy ethyl acetate (butyl gycol acetate), propylene glycol diacetate, ethyl 3-ethoxypropionate, 3-methoxybutyl acetate, butyldiglycol acetate, 2,2,4-trimethyl-1,3-pentanediol diisobutyrate and propylene carbonate. Examples of ketones are acetone, methyl ethyl ketone and methyl isobutyl ketone. Examples of amides are dimethylformamide (DMF) and N-methyl pyrrolidone (NMP). Example of ethers are glycol ethers such as dipropylene glycol dimethylether, and cyclic ethers such as tetrahydrofurane and 1,4-dioxane. Examples of aromatic hydrocarbons are xylene and Solvesso 100.

A preferred organic solvent is an ester are mixtures thereof, in particular 2,2,4-trimethyl-1,3-pentanediol diisobutyrate.

The weight ratio of solvent (E) to the sum of polyester (A) and reactive diluent (B) is preferably in the range of 0 to 10%, more preferably in the range of 0.05 to 5%, and most preferably in the range of 0.1 to 2%.

The coating composition additive (F) can be any suitable coating composition additive.

Examples of coating composition additives are leveling agent and defoaming agent, light stabilizers, antistatic agents, flame retardants, thickeners, thixotropic agents, surface-active agents, viscosity modifiers, plasticizers, chelating agents, pigment, dyes and fillers.

The polymer (G) different from the unsaturated polyester (A) can be any suitable polymer different from unsaturated polyester (A).

Examples of polymer (G) are polyether acrylates, epoxide acrylates, urethane acrylates or polyester acrylates.

Preferably, the coating composition of the present invention does not comprise polymer (G).

Preferred coating composition of the present invention are coating compositions, wherein the weight ratio of the sum of the at least one unsaturated polyester (A) comprising units of formula

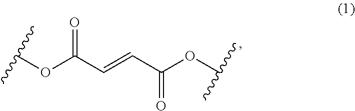

the reactive diluent (B) comprising at least one polymerizable compound (B1), at least one catalyst (C), optionally at least one actinic radiation-curable polymerization initiator (D), and optionally at least one solvent (E) to the weight of the coating composition is at least 80%, more preferably at least 90, and most preferably at least 95%,

More preferred coating composition composition of the present invention are coating compositions consisting essentially of at least one unsaturated polyester (A) comprising units of formula

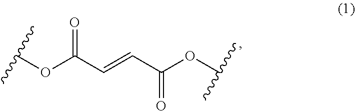

a reactive diluent (B) comprising at least one polymerizable compound (B1), at least one catalyst (C), optionally at least one actinic radiation-curable polymerization initiator (D) and optionally at least one solvent (E).

“Consting essentially of” means that the weight ratio of the sum of the at least one unsaturated polyester (A) comprising units of formula

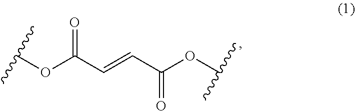

the reactive diluent (B) comprising at least one polymerizable compound (B1), at least one catalyst (C), optionally at least one actinic radiation-curable polymerization initiator (D) and optionally at least one solvent (E) to the weight of the coating composition is at least 95%.

The coating compositions of the present invention can be prepared by mixing the ingredients in any order. Preferably, the unsaturated polyester (A) is first mixed with reactive diluent (B) at elevated temperatures, such as in the range of 50 to 150° C., and then mixed with the remaining ingredients, preferably at room temperature.

Also part of the present invention is a composition consisting of at least one unsaturated polyester (A) comprising units of formula

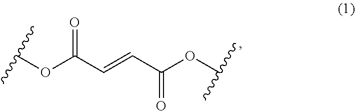

a reactive diluent (B) comprising at least one polymerizable compound (B1),
at least one catalyst (C), and
optionally at least one solvent (E).

The composition does not comprise peroxide.

The unsaturated polyester (A), the reactive diluent (B) comprising the at least one polymerizable compound (B1), the at least one catalyst (C) and the at least one solvent (E), as well as the weight ratios of reactive diluent (B) to unsaturated polyester (A), of catalyst (C) to the sum of reactive diluent(B) and unsaturated polyester (A) as well as of solvent (E) to the sum of reactive diluent(B) and unsaturated polyester (A) of this composition are as defined above for the coating composition of the present invention.

Also part of the present invention is the use of the composition of the present invention in the coating composition of the present invention.

Also part of the present invention is a substrate coated with the coating composition of the present invention.

The substrate can be any suitable substrate.

Examples of suitable substrates are wood-based substrates, stone, paper, cardboard, paperboard, textile, film, leather, nonwoven, plastics surfaces, glass, ceramic, mineral building materials, such as molded cement blocks and fiber-cement slabs, and metals, which in each case can be optionally precoated or pretreated

Wood-based substrate are all substrate comprising wood such as wood or veneer wood.

Preferably, the substrate is a wood-based substrate or stone. More preferably, the substrate is a wood-based substrate, even more preferably, the substrate is wood or veneered wood, and most preferably the substrate is veneered oak.

Also part of the present invention is a process for preparing a substrate coated with the coating composition of the present invention, which process comprises the steps of (i) applying the coating composition of the present invention to a substrate to form a layer and (ii) treating the layer with actinic radiation or by electron beam.

The coating composition can be be applied to the substrate by any method known in the art such as by spraying, rolling, brushing, doctor blades, various printing processes such as gravure, transfer, lithographica and ink jet printing and by using a bar.

The thickness of the “wet” layer formed from the coating composition of the present invention is usually in the range of 3 to 500 μm, preferably in the range of 5 to 150 μm, more preferably in the range of 5 to 80 μm.

Preferably, the treatment of the layer in step (ii) is performed by UV radiation.

Preferably, the substrate is a wood-based substrate or stone. More preferably, the substrate is a wood-based substrate, even more preferably, the substrate is wood or veneered wood, and most preferably the substrate is veneered oak.

The coating composition of the present invention are advantageous in that the coating compositions do not comprise peroxide and thus do not show the disadvantages of peroxide-comprising coating compositions such as being a two-component-coating composition and requiring extra safety and health measures due to the peroxide component. Instead, the coating composition of the present invention is a one-component coating composition and does not require special safety and health measures.

The coating composition of the present invention is also advantageous in that the amount of reactive diluent (B) comprising polymerizable compounds B1, which is extractable from substrates, in particular from wood-based substrates such as veneered oak substrates, coated with the coating composition of the present invention considerably decreases over a period of about months following treatment of the layer with actinic radition or electron beam, in particular with UV radiation. For coating compositions of the present invention comprising a reactive diluent essentially consisting of the polymerizable compound dipropylene glycol diacrylate (DPGDA), for example, the amount of DPGDA extractable from coated veneered oak substrate decreases from 11000 mg/m² to 400 mg/m² upon storage over a period of 22 weeks after UV radiation treatment of the layer formed from the coating composition.

As only not-reacted polymerizable compound can be extracted from the coated substrates, a decrease in the amount of extractable polymerizable compound over a period of about 5 months following treatment of the layer with actinic radiation or electron beam shows that the reactive diluent (B) comprising polymerizable compounds B1, in the substrate, in particular in wood substrates such as venered oak substrates, continues to react and crosslink with the unsaturated polyester (A) over a period of about 5 months following the treatment with actinic radiation or electron beam. This is, in particular, advantageous when using wood-based substrates such as veneered oak substrates, because the parts of the coating composition, which have penetrated into the wood-based substrate, cannot be reached by actinic radiation or electron beam treatment. Not reacted polymerizable compounds still present in the coated substrate represent a health and safety issue.

Without being bound by theory, it is stipulated that the polymerizable compounds of the coating composition of the present invention, continue to react and to crosslink the unsaturated polyester molecules (A) by oxygen-initiated mechanism after treatment of the layer with actinic radiation or electron beam.

Thus, the amount of polymerizable compounds extractable from the substrates coated with the coating composition of the present invention can conveniently be decreased by simply storing the coated substrates after curing for a period of about 5 months.

The coating composition of the present invention is also advantageous in that the hardness, in particular the pendulum hardness and the indentation hardness, of actinic radiation or electron beam treated layers of the coating compositions on a substrate increase over a period of about 5 months following radiation or electron beam treatment. The pendulum hardness of a cured layer formed from coating compositions of the present invention comprising a reactive diluent essentially consisting of the polymerizable compound dipropylene glycol diacrylate (DPGDA), for example, increase over a period of 22 weeks following curing from 47 to 98 oscillations. The indentation hardness of a cured layer formed from coating compositions of the present invention comprising a reactive diluent essentially consisting of the polymerizable compound dipropylene glycol diacrylate (DPGDA), for example, increase over a period of 22 weeks following curing from 122 to 264 N/mm².

Thus, the hardness of the layer formed from the coating compositions of the present invention can conveniently be increased by simply storing the coated substrates after curing for a period of about 5 months.

The coating composition of the present invention is also advantageous in that the viscosity of the coating composition does not significantly change when stored in a closed container over a period of about 9 months.

The coating compositions of the present invention containing low to zero amounts of solvent (E) and/or no styrene-type compounds are also advantageous in that the coating compositions have a low to zero amount of volatile organic compounds.

The coating composition of the present invention is also advantageous in that the coating composition do not crack upon curing. The coating composition of the present invention is also advantageous in that the coating composition shows a good adhesion to substrates, in particular to wood-based substrates. The coating composition of the present invention is also advantageous in that the coating composition shows a good chemical and mechanical resistance.

### EXAMPLES

### Abbreviations

DPGDA is dipropylene glycol diacrylate, GPTA is glycerol propoxylated triacrylate (average 3.8 propylene oxide units per molecule), CHMA is cyclohexyl methacrylate, HDDA is hexane-1,6-diol diacrylate, NMA is 2-norbornyl methacrylate, Omnirad 184 is 1-hydroxycyclohexyl phenyl ketone), Pergaquick C60X is 6% solution of cobalt bis(2-ethyl-hexanoate) in 2,2,4-trimethyl-1,3-pentanediol diisobutyrate, Nouryact CF40 comprises an iron complex.

### Example 1

### Preparation of a Mixture of an Unsaturated Polyester (A1) Comprising Units of Formulae (1), (2) and (3), and Dipropylene Glycol Diacrylate (DPGDA) as a Polymerizable Compound

1.44 weight parts diethylene glycol (MW 106.12 g/mol, 1.36 mol parts), 1 weight parts maleic anhydride (MW 98.06 g/mol, 1.02 mol parts) and 0.57 weight parts 1,2,3,6-tetrahydrophthalic anhydride (MW 152.15 g/mol, 0.37 mol parts) were reacted first at temperatures from 140 to 200° C., and later at 220° C. until the desired molecular weight was reached. The water formed during the esterification was removed by distillation. Under the reaction conditions (220° C.) the maleic acid derived units partially isomerized to fumaric acid derived units. The reaction mixture was cooled to temperatures below 130° C. and diluted with dipropylene glycol diacrylate to yield a mixture comprising 55 weight % of an unsaturated polyester (A1) and 45 weight % DPGDA based on the weight of the mixture.

The molar ratio of the units of formula (1)/units of formula (2)/units of formula (3) in the unsaturated polyester (A1) is 2.48/0.27/1.00 (determined by ¹H-NMR), the Mw of the unsaturated polyester (A1) is 4279 g/mol and the Mn is 892 g/mol.

### Example 2

### Preparation of a Mixture of an Unsaturated Polyester (A1) Comprising Units of Formulae (1), (2) and (3), and Glycerol Propoxylated Triacrylate as Polymerizable Compound (Average 3.8 PO Units Per Molecule, MW 475 g/mol)

1.44 weight parts diethylene glycol (MW 106.12 g/mol, 1.36 mol parts), 1 weight parts maleic anhydride (MW 98.06 g/mol, 1.02 mol parts) and 0.57 weight parts 1,2,3,6-tetrahydrophthalic anhydride (MW 152.15 g/mol, 0.37 mol parts) were reacted first at temperatures from 140 to 200° C., and later at 220° C. until the desired molecular weight was reached. The water formed during the esterification was removed by distillation. Under the reaction conditions (220° C.) the maleic acid derived units partially isomerized to fumaric acid derived units. The reaction mixture was cooled to temperatures below 130° C. and diluted with glycerol propoxylated triacrylate (average 3.8 PO units per molecule, MW 475 g/mol) to yield a mixture comprising 40 weight % of a polyolefinically unsaturated polyester (A1) and 60 weight % glycerol propoxylated triacrylate (average 3.8 PO units per molecule, MW 475 g/mol) based on the weight of the mixture.

The molar ratio of the units of formula (1)/units of formula (2)/units of formula (3) in the unsaturated polyester (A1) is 2.48/0.27/1.00 (determined by ¹H-NMR), the Mw of unsaturated polyester (A1) is 4279 g/mol and the Mn is 892 g/mol.

### Example 3

### Preparation of a Coating Composition Comprising the Mixture of Example 1

75 g of the mixture of example 1, 25 g dipropyleneglycol diacrylate, 4 g Omnirad 184 and 1 g Pergaquick C60X were mixed at room temperature to yield a coating composition.

Examples 4 to 11

### Preparation of Coating Compositions Comprising the Mixture of Example 1

Coating compositions comprising the mixture of example 1 were prepared in analogy to example 3, but with the ingredients listed in table 1.

TABLE 1

| | Amounts ingredients [g] | | | | | | | | |
|---|---|---|---|---|---|---|---|---|---|
| ingredients | Ex 3 | Ex4 | Ex 5 | Ex 6 | Ex 7 | Ex 8 | Ex 9 | Ex 10 | Ex 11 |
| mixture Example 1 | 75 | 75 | 75 | 75 | 75 | 75 | 75 | 75 | 75 |
| DPGDA | 25 | | | | | | | | |
| GPTA | | 25 | 25 | | | | | | |
| CHMA | | | | 25 | 25 | | | | |
| HDDA | | | | | | 25 | 25 | | |
| NMA | | | | | | | | 25 | 25 |
| Omnirad 184 | 4 | 4 | 4 | 4 | 4 | 4 | 4 | 4 | 4 |
| PergaQuick C60X | 1 | 1 | | 1 | | 1 | | 1 | |
| Nouryact CF40 | | | 1 | | 1 | | 1 | | 1 |

### Comparative Examples 1 to 5

### Preparation of a Coating Compositions Comprising the Mixture of Example 1, but No Catalyst

Comparative coating compositions comprising the mixture of example 1 were prepared in analogy to example 3, but with the ingredients listed in table 2.

TABLE 2

| | Amounts ingredients [g] | | | | |
|---|---|---|---|---|---|
| ingredients | CEx 1 | CEx 2 | CEx 3 | CEx 4 | CEx 5 |
| mixture Example 1 | 75 | 75 | 75 | 75 | 75 |
| DPGDA | 25 | | | | |
| GPTA | | 25 | | | |
| CHMA | | | 25 | | |
| HDDA | | | | 25 | |
| NMA | | | | | 25 |
| Omnirad 184 | 4 | 4 | 4 | 4 | 4 |
| PergaQuick C60X | | | | | |
| Nouryact CF40 | | | | | |

### Comparative Examples 6 to 9

### Preparation of a Coating Compositions Comprising Laromer® PE9074 and Laromer® PE8800, Respectively

Comparative coating composition comprising Laromer® PE9074 and Laromer® PE8800, respectively, were prepared in analogy to example 3, but with the ingredients listed in table 3.

Laromer® PE9074 comprises a polyester having no olefinically unsaturated units in the main chain of the polyester but carrying acrylic acid-derived groups in the side chains of the polyester, and reactive diluent.

Laromer® PE8800 comprises a polyester having maleic acid-derived units in the main chain of the polyester and carrying acrylic acid-derived groups in the side chains of the polyester, and a reactive diluent.

TABLE 3

Amount ingredients [g]

| ingredients | CEx 6 | CEx 7 | CEx 8 | CEx 9 |
|---|---|---|---|---|
| Laromer ® PE9074 | 75 | 75 | | |
| Laromer ® PE8800 | | | 75 | 75 |
| DPGDA | | | | |
| GPTA | 25 | 25 | 25 | 25 |
| Omnirad 184 | 4 | 4 | 4 | 4 |
| PergaQuick C60X | 1 | | 1 | |
| Nouryact CF40 | | 1 | | 1 |

### Example 12

### Determination of the Amount of Dipropylene Glycol Diacrylate (DPGDA) Extractable from UV-irradiated Veneered Oak Substrates Coated with of the Coating Compositions of Example 3 and of Comparative Example 1, Respectively

The coating composition of example 3 and comparative example 1, respectively, was applied with a roller coater BKL Bürkle on veneered oak substrates having a size (length×width) of 10 cm² with a quantity of 40 g coating composition/m² veneered oak substrate. 1 Minute after application the coated substrates were irradiated using medium pressure Hg lamp with a power of 160 W/cm and a conveyer belt speed of 10 m/min.

After UV irradiation, the coated veneered oak substrates were kept in the dark at room temperature. DPGDA was extracted from the coated veneered oak substrates using acetone (80° C., 1.5 h) according to IKEA IOS™ 0002 directly after UV-irradiation and after 4, 10 and 22, respectively, weeks after UV-irradiation. The amount of extractable DPGDA was determined by gas chromatography.

TABLE 4

Amount of extractable DPGDA [mg/m²]

| Week | Ex 3 | CEx 1 |
|---|---|---|
| 0 | 11000 | 10900 |
| 4 | 1350 | 7250 |
| 10 | 1100 | 7185 |
| 22 | 400 | 2950 |

Table 4 shows that the amount of DPGDA extractable from veneered oak substrates coated with coating composition of example 3 comprising unsaturated polyester A1, DPGDA, UV-radiation curable polymerization initiator Omnirad 184 and catalyst PergaQuick C60X decreases over a period of 22 weeks following UV irradiation from 11000 mg/m² to only 400 mg/m², whereas the amount of DPGDA extractable from veneered oak substrates coated with the coating composition of comparative example 1 comprising unsaturated polyester Al, DPGDA, UV-radiation curable polymerization initiator Omnirad 184 but no catalyst PergaQuick C60X only decreases over a period of 22 weeks following UV-irradition from 10900 mg/m² to 2950 mg/m².

As only not-reacted DPGDA can be extracted from the coated substrates, a decrease in the amount of extractable DPGDA over a period of 22 weeks following UV irradiation shows that DPGDA in the coated substrate continues to react over a period of 22 weeks following UV irradiation.

Thus, the amount of not-reacted DPGDA of veneered oak substrates coated with the coating composition of example 3 can conveniently be decreased by simply storing the coated substrates after UV irradiation for a period of 22 weeks.

### Example 13

### Determination of the Amount of the Polymerizable Compounds (DPGDA, GPTA, CHMA, HDDA and NMA) Extractable from UV-irradiated Veneered Oak Substrates Coated with of the Coating Composition of Example 3, 6, 7, 8 and 10, Respectively

The coating composition of examples 3, 6, 7, 8, and 10, respectively, was applied with a roller coater BKL Bürkle on veneered oak substrates having a size (length×width) of 10 cm² with a quantity of 27 g coating composition/m² veneered oak substrate and 1 minute after application irradiated using medium pressure Hg lamp with a power of 120 W/cm and a conveyer belt speed of 5 m/min. After UV irradiation, the coated veneered oak substrates were kept in the dark at room temperature. The polymerizable compounds (DPGDA, CHMA, HDDA and NMA) were extracted from the coated veneered oak substrates using acetone (80° C., 1.5 h) according to IKEA IOS™ 0002 directly after UV-radiation and after 8, 12 and 20, respectively, weeks after UV-irradiation. The amount of extractable polymerizable compounds (DPGDA, CHMA, HDDA and NMA) was determined by gas chromatography.

TABLE 5

| | Amount extractable Polymerizable Compound [mg/m²] | | | | | | | | |
|---|---|---|---|---|---|---|---|---|---|
| | Ex 3 | Ex 6 | | Ex 7 | | EX8 | | Ex 10 | |
| Week | DPGDA | CHMA | DPGDA | CHMA | DPGDA | HDDA | DPGDA | NMA | DPGDA |
| 0 | 6700 | 3800 | 5000 | 5400 | 6700 | 4200 | 6100 | 4500 | 5100 |
| 8 | 475 | 120 | 710 | <50 | 2350 | 210 | 295 | 240 | 780 |
| 12 | 460 | 107 | 660 | <50 | 2150 | 210 | 270 | 225 | 740 |
| 20 | 460 | 107 | 580 | <50 | 1300 | nd | nd | 120 | 700 |

Table 5 shows that the amount of all polymerizable compounds (DPGDA, CHMA, HDDA and NMA, respectively) extractable from veneered oak substrates coated with coating composition of example 3, 6, 7, 8 and 10 comprising unsaturated polyester A1, at least one polymerizable compound, UV-curable initiator Omnirad 184 and catalyst PergaQuick C60X or Nouryact CF40 decrease over a period of 20 weeks following UV irradiation,

As only not-reacted polymerizable compounds (DPGDA, CHMA, HDDA and NMA, respectively) can be extracted from the coated substrates, a decrease in the amount of extractable polymerizable compounds over a period of 20 weeks following UV irradiation shows that the polymerizable compound in the coated substrate continues to react over a period of 20 weeks following UV irradiation.

Thus, the amount of not-reacted polymerizable compound (DPGDA, CHMA, HDDA and NMA, respectively) of veneered oak substrates coated with the coating composition of example 3, 6, 7, 8 and 10 can conveniently be decreased by simply storing the coated substrates after UV radiation for a period of 20 weeks.

### Example 14

### Analysis of the Curing Behaviour of Samples of the Coating Compositions of Examples 3 to 11 and of Comparative Examples 1 to 9 in an Open Metal Sheet Lid without Applying Actinic Radiation or Electron Beam

2 g of the liquid coating compositions of examples 3 to 11 and of comparative examples 1 to 9, respectively, was placed in a sheet metal lid having a diameter of 4 cm. The “sheet metal lid with the samples of the coating composition was kept “open” at room temperature in the dark. The curing behavior of the samples of the coating composition was monitored by weekly inspecting with a spatula whether the core of the sample of coating composition in the sheet metal lid is solid or liquid. After 36 weeks the test was stopped. The time period in weeks the core of the samples of coating composition of examples 1 to 11 in the sheet metal lid needed to become solid is shown in table 6. The cores of the samples of the coating compositions of comparative examples 1 to 9 were still liquid after 36 weeks.

TABLE 6

| Coating composition | Ex 3 | Ex4 | Ex 5 | Ex 6 | Ex 7 | Ex 8 | Ex 9 | Ex 10 | Ex 11 |
|---|---|---|---|---|---|---|---|---|---|
| Time period the | 8 | 14 | 15 | 11 | 11 | 17 | 11 | 8 | 15 |
| core of the sample | | | | | | | | | |
| needs to become | | | | | | | | | |
| solid [weeks] | | | | | | | | | |

Table 6 shows that the core of the samples of the coating compositions of examples 3 to 11 in the sheet metal lid become solid after a time period of between 8 and 17 weeks. It is stipulated that that the polymerizable compounds of the coating composition of the present invention react and crosslink to the unsaturated polyester molecules (A) by oxygen-initiated mechanism upon storage.

### Example 15

### Determination of the Pendulum Hardness of UV-irradiated Layers of the Coating Compositions of Examples 3, 4 and 8 and of Comparative Examples 1, 2, 4, 6, 7, 8 and 9

The coating composition of examples 3, 4 and 8 and of comparative examples 1, 2, 4, 6, 7, 8 and 9, respectively, was applied with a bar on a glass substrate (thickness of wet layer: 400 μm) and irradiated using a medium pressure Hg lamp with a power of 120 W/cm and a conveyer belt speed of 10 m/min. After UV irradiation, the coated glass substrates were kept at room temperature in the dark and the pendulum hardness was determined directly after UV curing and after the weeks indicated in tables 7 and 8 using DIN EN ISO 1522 (04-2007).

The pendulum hardness of the UV-irradiated layers of the coating compositions of examples 3 and comparative example 1 can be seen in table 7.

TABLE 7

Pendulum Hardness
[number of oscillations]

| Week | Ex 3 | CEx 1 |
|---|---|---|
| 0 | 47 | 50 |
| 1 | 58 | 55 |
| 2 | 64 | 54 |
| 4 | 74 | 54 |
| 8 | 84 | 56 |
| 10 | 95 | 58 |
| 18 | 98 | 56 |

Table 7 shows that the pendulum hardness of the UV-irradiated layer of the coating compositions of examples 3 comprising unsaturated polyester A1, DPGDA, UV-radiation curable polymerization initiator Omnirad 184 and catalyst PergaQuick C60X increase over a period of 18 weeks following UV irradiation from 47 to 98 oscillations, whereas the pendulum hardness of the UV-irradiated layer of the coating compositions of comparative example 1 comprising unsaturated polyester A1, DPGDA, UV-radiation curable polymerization initiator Omnirad 184 but no catalyst PergaQuick C60X only increase over a period of 26 weeks following UV-irradition from 50 to 56 oscillations.

The pendulum hardness of the UV-irradiated layers of the coating compositions s of examples of examples 4 and 8 and comparative examples 2, 4, 6, 7, 8 and 9 can be seen in table 8.

TABLE 8

| | Pendulum Hardness [number of oscillations] | | | | | | | |
|---|---|---|---|---|---|---|---|---|
| Week | Ex4 | Ex 8 | CEx 2 | CEx 4 | CEx 6 | CEx 7 | CEx 8 | CEx 9 |
| 0 | 39 | 48 | 42 | 50 | 21 | 21 | 61 | 63 |
| 6 | 69 | 82 | 39 | 55 | 20 | 21 | 64 | 70 |
| 8 | 72 | 88 | 44 | 55 | 20 | 21 | 62 | 69 |
| 10 | 76 | 89 | 45 | 55 | 20 | 21 | 63 | 70 |
| 12 | 78 | 89 | 45 | 54 | 19 | 20 | 64 | 71 |
| 16 | 83 | 93 | 46 | 55 | 20 | 21 | 64 | 70 |
| 20 | 87 | 97 | 51 | 54 | 21 | 21 | 63 | 70 |
| 26 | 91 | 99 | 54 | 55 | 23 | 24 | 65 | 58 |

Table 8 shows that the pendulum hardness of the UV-irradiated layer of the coating compositions of examples 4 comprising unsaturated polyester A1, DPGDA, GPTA, UV-radiation curable polymerization initiator Omnirad 184 and catalyst PergaQuick C60X increase over a period of 26 weeks following UV irradiation from 38 to 91 oscillations, whereas the pendulum hardness of the UV-irradiated layer of the coating compositions of comparative example 2 comprising unsaturated polyester A1, DPGDA, GPTA, UV-radiation curable polymerization initiator Omnirad 184 but no catalyst PergaQuick C60X only increase over a period of 26 weeks following UV-irradition from 42 to 54 oscillations.

Table 8 also shows that the pendulum hardness of the UV-irradiated layer of the coating compositions of examples 8 comprising unsaturated polyester A1, DPGDA, HDDA, UV-radiation curable polymerization initiator Omnirad 184 and catalyst PergaQuick C60X increase over a period of 26 weeks following UV irradiation from 48 to 99 oscillations, whereas the pendulum hardness of the UV-irradiated layer of the coating compositions of comparative example 4 comprising unsaturated polyester A1, DPGDA, HDDA, UV-radiation curable polymerization initiator Omnirad 184 but no catalyst PergaQuick C60X only increase over a period of 26 weeks following UV-irradition from 50 to 55 oscillations.

Table 8 also shows that the pendulum hardness of the UV-irradiated layer of the coating compositions of comparative examples 6 to 9 comprising no unsaturated polyester comprising units of formula (1) show almost no increase in pendulum hardness over a period of 26 weeks.

### Example 16

### Determination of the Indentation Hardness [N/mm²] of the UV-irradiated Layers of the Coating Compositions of Example 3 and of Comparative Example 1

The coating composition of example 3 and of comparative example 1, respectively, was applied with a bar on a glass substrate (thickness of wet layer: 400 μm) and irradiated using a medium pressure Hg lamp with a power of 120 W/cm and a conveyer belt speed of 10 m/min. The glass substrate coated with the UV-cured layer was kept at room temperature in the dark and the indentation hardness was determined directly after UV radiation treatment and 1, 2, 4, 8, 10, 14, 35 18, 22, 30 and 32 weeks after UV irradiation using DIN EN ISO 14577-1 (2000).

The results are shown in table 9

TABLE 9

Indentation hardness [N/mm²]

| Week | Ex 3 | CEx 1 |
|---|---|---|
| 0 | 122 | 134 |
| 1 | 181 | 156 |
| 2 | 204 | 158 |
| 4 | 241 | 161 |
| 8 | 267 | 167 |
| 10 | 281 | 178 |
| 14 | 265 | 164 |
| 18 | 268 | 163 |
| 22 | 264 | 156 |

Table 9 shows that the indentation hardness of the UV-irradiated layer of the coating composition of example 3 comprising unsaturated polyester A1, DPGDA, UV-radiation curable polymerization initiator Omnirad 184 and catalyst PergaQuick C60X increase over a period of 22 weeks following UV irradiation from 122 to 264 N/mm², whereas the indentation hardness of the UV-irradiated layer of the coating composition of comparative example 1 comprising unsaturated polyester A1, DPGDA, UV-radiation curable polymerization initiator Omnirad 184 but no catalyst PergaQuick C60X only increase over a period of 22 weeks following UV-irradition from 134 to 156 N/mm².

### Example 15

### Determination of the Viscosity of the Coating Composition of Examples 3 and Comparative Example 1 When Stored in a Closed Container at Room Temperature

The coating composition of example 3 and of comparative example 1 were stored in a closed container at room temperature, and the viscosity of the coating compositions were measured at 23° C. using DIN EN ISO 2555 (2018) after the weeks indicated in table 10.

The results are shown in table 10.

TABLE 10

Viscosity [mPa × s]

| Week | Ex 3 | CEx 1 |
|---|---|---|
| 0 | 830 | 840 |
| 1 | 800 | 830 |
| 2 | 780 | 820 |
| 4 | 800 | 830 |
| 8 | 820 | 820 |
| 12 | 810 | 830 |
| 16 | 790 | 760 |
| 20 | 760 | 730 |
| 24 | 740 | 720 |
| 28 | 720 | 710 |
| 32 | 730 | 720 |
| 36 | 750 | 700 |

Table 10 shows that the viscosity of the liquid coating composition of example 3 comprising unsaturated polyester A1, DPGDA, UV-radiation curable polymerization initiator Omnirad 184 and catalyst PergaQuick C60X only slightly decreases when stored in a closed container over a period of 36 weeks from 830 to 750 mPa×s, and that the viscosity of the liquid coating composition of example 3 is comparable to the viscosity of the liquid coating composition of comparative example 1 comprising unsaturated polyester A1, DPGDA, UV-radiation curable polymerization initiator Omnirad 184 but no catalyst PergaQuick C60X.

Thus, the presence of catalyst PergaQuick C60X in the coating composition of example 3 does not influence the viscosity of the coating composition when stored in a closed container over a period of 36 weeks.

1. A coating composition comprising:
at least one unsaturated polyester (A) comprising units of formula 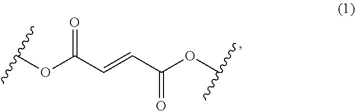
a reactive diluent (B) comprising at least one polymerizable compound (B1),
at least one catalyst (C),
optionally at least one actinic radiation-activatable polymerization initiator (D),
optionally at least one solvent (E),
optionally at least one coating composition additive (F), and
optionally at least one polymer (G) different from the unsaturated polyester (A),
with the proviso that the coating composition does not comprise any peroxide.

2. The coating composition of claim 1 wherein the unsaturated polyester (A) comprises
units of formula 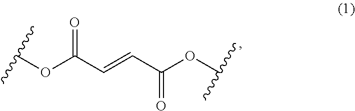
units of formula 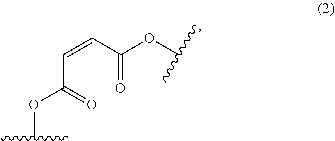
optionally units derived from at least one dicarboxylic acid carrying at least one olefinically unsaturated group or derivative thereof, different from the units of formula (1) or (2),
and
units derived from at least one diol.

3. The coating composition of claim 2, wherein the molar ratio of units of formula (1) to the sum of units of formulae (1) and (2) is in the range of 50 to 99%.

4. The coating composition of claim 2, wherein the molar ratio of units of formula (1) to the sum of units of formula (1), units of formula (2) and units derived from at least one dicarboxylic acid carrying at least one olefinically unsaturated group or derivative thereof different from the units of formula (1) and (2), is the range of 50 to 90%.

5. The coating composition of claim 2, wherein the units derived from at least one dicarboxylic acid carrying at least one olefinically unsaturated group or derivative different from the units of formulae (1) and (2) comprise units of formula

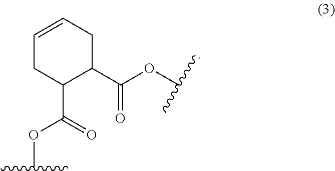

6. The composition of claim 2, wherein the diol is a diol carrying no olefinically unsaturated groups.

7. The coating composition of claim 1, wherein the reactive diluent (B) consists of compounds carrying at least one (meth)acryloyl group.

8. The coating composition of claim 1 wherein the polymerizable compound (B1) is selected from the group consisting of diethyleneglycol di(meth)acrylate, triethylene glycol di(meth)acrylate, tetrathylene glycol di(methacrylate), dipropylene glycol di(meth)acrylate, tripropylene glycol di(meth)acrylate and tetrapropylene glycol di(meth)acrylate.

9. The coating composition of claim 8, wherein the polymerizable compound (B1) is dipropylene glycol diacrylate.

10. The coating composition of claim 9, wherein the weight ratio of the polymerizable compound (B1) to the reactive diluent (B) is at least 40%.

11. The coating composition of claim 1, wherein the catalyst (C) is a metal salt or a metal complex, wherein the metal is cobalt or iron.

12. The composition of claim 11, wherein the metal is cobalt.

13. The coating composition of claim 12, which comprises at least one actinic radiation activatable polymerization initiator (D).

14. The coating composition of claim 13, wherein the actinic radiation activatable polymerization initiator (D) is a UV radiation-activatable polymerization initiator.

15. A composition consisting of:
at least one unsaturated polyester (A) comprising units of formula 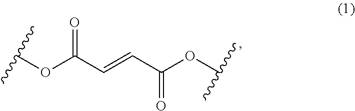
a reactive diluent (B) comprising at least one polymerizable compound (B1),
at least one catalyst (C), and
optionally at least one solvent (E).

16. A method of using a composition consisting of:
at least one unsaturated polyester (A) comprising units of formula 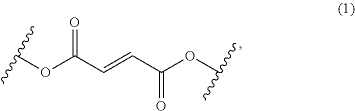
a reactive diluent (B) comprising at least one polymerizable compound (B1),
at least one catalyst (C), and
optionally at least one solvent (E), the method comprising using the composition in the coating composition of claim 1.

17. A substrate coated with the coating composition of claim 1.

18. The substrate of claim 17, wherein the substrate is a wood-based substrate.

19. A process for preparing the substrate of claim 17, the process comprising the steps of (i) applying the coating composition to a substrate to form a layer and (ii) treating the layer formed in step (i) with actinic radiation or electron beam.

20. The process of claim 19, wherein the substrate is a wood-based substrate.
